(19) United States
(12) Patent Application Publication
(10) Pub. No.: US 2026/0194716 A1
(43) Pub. Date: Jul. 9, 2026

(54) QUANTUM OPTICAL DEVICE

(71) Applicant: ELECTRONICS AND TELECOMMUNICATIONS RESEARCH INSTITUTE, Daejeon (KR)

(72) Inventor: Young-Ho KO, Daejeon (KR)

(21) Appl. No.: 19/431,658

(22) Filed: Dec. 23, 2025

(30) Foreign Application Priority Data
Dec. 31, 2024 (KR) 10-2024-0202211
Aug. 7, 2025 (KR) 10-2025-0108692

(51) Int. Cl. G02B 6/124; G02B 6/12

(52) U.S. Cl. CPC G02B 6/124; G02B 2006/12107

(57) ABSTRACT

Provided is a quantum optical device including a substrate, an optical waveguide disposed on the substrate to extend in a first direction parallel to a top surface of the substrate, a first sub-wavelength grating structure group and a second sub-wavelength grating structure group, which are disposed on the substrate and are spaced apart from each other in a second direction that is parallel to the top surface of the substrate and perpendicular to the first direction with the optical waveguide between the first sub-wavelength grating structure group and the second sub-wavelength grating structure group, and a quantum light source disposed on either one of first sub-wavelength grating structure group and the second sub-wavelength grating structure group. Each of the first sub-wavelength grating structure group and the second sub-wavelength grating structure group includes a plurality of sub-wavelength grating structures.

### CROSS-REFERENCE TO RELATED APPLICATIONS

This U.S. non-provisional patent application claims priority under 35 U.S.C. § 119 of Korean Patent Application Nos. 10-2024-0202211, filed on Dec. 31, 2024, and 10-2025-0108692, filed on Aug. 7, 2025, the entire contents of which are hereby incorporated by reference.

### BACKGROUND

### 1. Field of the Invention

The present disclosure herein relates to a quantum optical device, and more particularly, to a quantum optical device in which a quantum light source and an optical waveguide are heterogeneously integrated.

### 2. Description of Related Art

Quantum light sources may be utilized in technologies such as quantum communication, quantum computing, and quantum sensing. To generate a single-photon light source, structures such as compound semiconductor-based quantum dots or point defects within a solid may be utilized.

The compound semiconductor-based quantum dots may be implemented in compound semiconductors such as gallium arsenide (GaAs), indium phosphide (InP), indium gallium arsenide (InGaAs), and gallium nitride (GaN). The point defects within the solid may be implemented in wide bandgap materials such as diamond (D), silicon carbide (SiC), hexagonal boron nitride (hBN), etc., and may occur naturally in an atomic arrangement of a crystal structure or may be implemented by intentionally generating defects.

Although the compound semiconductor-based quantum dots and the point defects within the solid are structures capable of single-photon generation, their light extraction efficiency and generation rate may be limited due to their common location within the solid with a high refractive index. To improve this limitation, a combination of the single-photon light source and the optical waveguide may be used.

As a method for combining the single-photon light source and the optical waveguide, wafer bonding and micro-transfer methods may be used. Although the wafer bonding methods have excellent bonding strength and process stability, a production yield may be significantly deteriorated due to random location characteristics of the quantum dots or the point defects. On the other hand, in the micro-transfer method, selected high-quality chips may be coupled to the optical waveguide to expect high efficiency. However, when an alignment error occurs in a level of several hundred nm, optical coupling efficiency may be rapidly deteriorated.

To prevent the coupling efficiency from being deteriorated due to the alignment errors, a structure having high alignment tolerance may be designed, or an optical device having high tolerance may be manufactured using a method for actively compensating an error through application of an external voltage when an alignment error occurs.

### SUMMARY

The present disclosure provides a quantum optical device having high alignment tolerance.

The present disclosure also provides a quantum optical device having high coupling efficiency.

The object of the present disclosure is not limited to the aforesaid, but other objects not described herein will be clearly understood by those skilled in the art from descriptions below.

An embodiment of the inventive concept provides a quantum optical device including: a substrate; an optical waveguide disposed on the substrate to extend in a first direction parallel to a top surface of the substrate; a first sub-wavelength grating structure group and a second sub-wavelength grating structure group, which are disposed on the substrate and are spaced apart from each other in a second direction that is parallel to the top surface of the substrate and perpendicular to the first direction with the optical waveguide between the first sub-wavelength grating structure group and the second sub-wavelength grating structure group; and a quantum light source disposed on either one of first sub-wavelength grating structure group and the second sub-wavelength grating structure group, each of the first sub-wavelength grating structure group and the second sub-wavelength grating structure group comprises a plurality of sub-wavelength grating structures.

In an embodiment, the sub-wavelength grating structures may be disposed in a plurality of columns along the first direction, and each of the sub-wavelength grating structures may have a width in the second direction, which is greater than a width in the first direction.

In an embodiment, the sub-wavelength grating structures may be disposed in a plurality of rows and a plurality of columns along the first direction and the second direction.

In an embodiment, the sub-wavelength grating structures may be disposed in a plurality of rows along the second direction, and each of the sub-wavelength grating structures may have a width in the first direction, which is greater than a width in the second direction.

In an embodiment, the sub-wavelength grating structures adjacent to each other in the first direction among the sub-wavelength grating structures may be spaced apart from each other by a second distance in the first direction, wherein the second distance may be shorter than a wavelength of the quantum light source.

In an embodiment, the sub-wavelength grating structures adjacent to each other in the second direction among the sub-wavelength grating structures may be spaced apart from each other by a first distance in the second direction, wherein the first distance may be shorter than a wavelength of the quantum light source.

In an embodiment, each of the optical waveguide and the sub-wavelength grating structures may include a first material, and the quantum light source may include a second material, wherein the first material and the second material may be different from each other.

In an embodiment, the first material may be silicon (Si), silicon nitride (SiNx), or lithium niobate (LiNbO₃).

In an embodiment, the second material may be indium arsenide (InAs) quantum dots or indium gallium arsenide (InGaAs).

In an embodiment, the quantum light source and the sub-wavelength grating structures may be in contact with each other.

In an embodiment, the optical waveguide and the quantum light source may be spaced apart from each other.

In an embodiment, the optical waveguide and the quantum light source may be spaced apart from each other in the second direction in a planar view.

In an embodiment, the quantum light source may have a line shape with a sharp tip.

In an embodiment, the quantum light source may include a periodic hole inside the quantum light source and a reflective structure disposed inside the quantum light source.

In an embodiment, the quantum optical device may further include a piezoelectric material layer interposed between the substrate and the sub-wavelength grating structures.

In an embodiment, the quantum optical device may further include metal electrodes disposed on top and bottom surfaces of the piezoelectric material layer, respectively.

In an embodiment, the piezoelectric material layer may include a first recess and a second recess, wherein the first recess may be disposed between the first sub-wavelength grating structure group and the optical waveguide, and the second recess may be disposed between the second sub-wavelength grating structure group and the optical waveguide.

In an embodiment of the inventive concept, a quantum optical device includes: a substrate; an optical waveguide disposed on the substrate to extend in a first direction parallel to a top surface of the substrate; sub-wavelength grating structures disposed along both side surfaces of the optical waveguide on the substrate; and a quantum light source disposed on the sub-wavelength grating structures, wherein the optical waveguide and the quantum light source do not overlap each other.

In an embodiment, the sub-wavelength grating structures may be disposed in a plurality of columns along the first direction, and each of the sub-wavelength grating structures may have a width in a second direction parallel to the top surface of the substrate and perpendicular to the first direction, which is greater than a width of the sub-wavelength grating structure in the first direction.

In an embodiment, the sub-wavelength grating structures may be disposed in a plurality of rows along the second direction, and each of the sub-wavelength grating structures may have a width in the first direction, which is greater than a width in the second direction.

### BRIEF DESCRIPTION OF THE DRAWINGS

The accompanying drawings are included to provide a further understanding of the inventive concept, and are incorporated in and constitute a part of this specification. The drawings illustrate embodiments of the inventive concept and, together with the description, serve to explain principles of the inventive concept. In the drawings:

FIG. 1A is a plan view illustrating quantum optical devices according to some embodiments of the inventive concept;

FIG. 1B is a cross-sectional view taken along line A-A′ of FIGS. 1A and 3A;

FIGS. 2A, 2B, and 2C are cross-sectional views for explaining a method for manufacturing a quantum optical device according to some embodiments of the inventive concept;

FIG. 3A is a plan view illustrating quantum optical devices according to some embodiments of the inventive concept;

FIG. 3B is a cross-sectional view taken along line A-A′ of FIG. 3A;

FIG. 4 is a plan view of a quantum optical device according to some embodiments of the inventive concept;

FIG. 5 is a cross-sectional view illustrating quantum optical devices according to some embodiments of the inventive concept;

FIG. 6 is a cross-sectional view for explaining a method for manufacturing a quantum optical device according to some embodiments of the inventive concept;

FIG. 7 is a cross-sectional view illustrating quantum optical devices according to some embodiment of the inventive concept; and

FIG. 8 is a cross-sectional view illustrating quantum optical devices according to some embodiment of the inventive concept.

### DETAILED DESCRIPTION OF THE INVENTION

In order to sufficiently understand the configuration and effect of the present invention, some embodiments of the present invention will be described with reference to the accompanying drawings. The present disclosure may, however, be embodied in different forms and should not be construed as limited to the embodiments set forth herein. Rather, the exemplary embodiments are provided only to disclose the present invention and let those skilled in the art fully know the scope of the present invention. In the accompanying drawings, the components are shown enlarged for the sake of convenience of explanation, and the proportions of the components may be exaggerated or reduced for clarity of illustration.

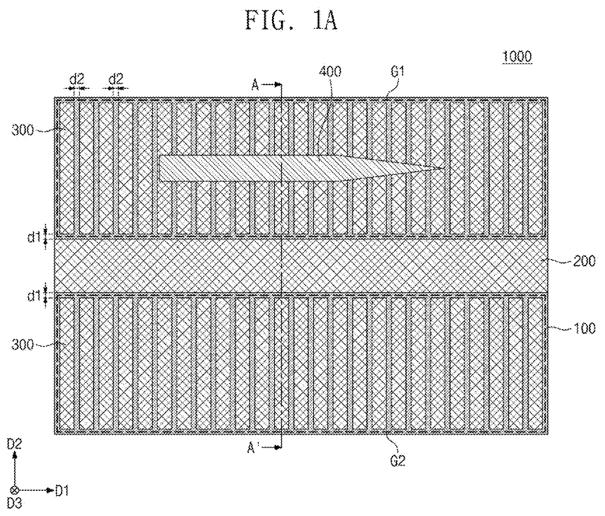

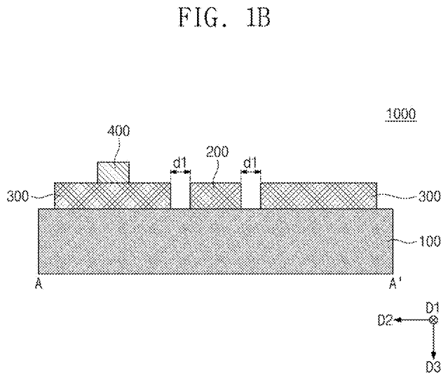

FIG. 1A is a plan view illustrating a quantum optical device 1000 according to some embodiments of the inventive concept, and FIG. 1B is a cross-sectional view taken along line A-A′ of FIG. 1A.

Referring to FIGS. 1A and 1B, the quantum optical device 1000 according to embodiments may include a substrate 100, an optical waveguide 200, sub-wavelength grating structures 300, and a quantum light source 400.

The substrate 100 may be, for example, a silicon substrate or a silicon oxide substrate.

The optical waveguide 200 may be disposed on the substrate 100. The optical waveguide 200 may extend in a first direction D1. In this specification, the first direction D1 may be defined as one direction parallel to a top surface of the substrate 100. The optical waveguide 200 may include a first material. The first material may include silicon (Si), silicon nitride (SiNx), lithium niobate (LiNbO₃), etc.

The sub-wavelength grating structures 300 may be disposed on the substrate 100. The sub-wavelength grating structures 300 may provide a first sub-wavelength grating structure group G1 and a second sub-wavelength grating structure group G2. The first sub-wavelength grating structure group G1 and the second sub-wavelength grating structure group G2 may be spaced apart from each other in a second direction D2 with the optical waveguide 200 between the first sub-wavelength grating structure group G1 and the second sub-wavelength grating structure group G2. In this specification, the second direction D2 may be defined as a direction parallel to the top surface of the substrate 100 and perpendicular to the first direction D1.

The sub-wavelength grating structures 300 may be arranged in a plurality of columns along the first direction D1 within the first sub-wavelength grating structure group G1 and the second sub-wavelength grating structure group G2. The sub-wavelength grating structures 300 may be spaced apart from the optical waveguide 200 in the second direction D2. Each of the sub-wavelength grating structures 300 may have a width in the second direction D2, which is greater than a width in the first direction D1.

The first sub-wavelength grating structure group G1 and the second sub-wavelength grating structure group G2 may be spaced apart from each other by a first distance d1 in the second direction D2 with respect to the optical waveguide 200. The first distance d1 may range of about 10 nm to about 200 nm. The sub-wavelength grating structures 300 may be spaced apart from each other by a second distance d2 in the first direction D1. The second distance d2 may be shorter than a wavelength of the quantum light source. The second distance d2 may range, for example, of about 50 nm to about 2 μm. Each of the sub-wavelength grating structures 300 may have a length in the second direction D2, and the length may range of about 100 nm to about 5 μm. Each of the sub-wavelength grating structures 300 may have a width in the first direction D1, and the width may range of about 100 nm to about 2 μm.

Due to the sub-wavelength grating structures 300, an allowable error may increase. In more detail, in the case in which an alignment error occurs between the quantum light source 400 and the optical waveguide 200, the sub-wavelength grating structures 300 may selectively diffract and refract a photon wave having a specific wavelength to efficiently transfer photons emitted from the quantum light source 400 to the optical waveguide 200. The sub-wavelength grating structures 300 may be spaced apart from the optical waveguide 200 to further enhance this effect. Each of the sub-wavelength grating structures 300 may include a first material. The first material may include silicon (Si), silicon nitride (SiNx), and lithium niobate (LiNbO₃), etc. Alternatively, the sub-wavelength grating structures 300 may be made of the same material as the optical waveguide 200.

The quantum light source 400 may be disposed on the sub-wavelength grating structures 300. In detail, the quantum light source 400 may be selectively disposed on one of the first sub-wavelength grating structure group G1 and the second sub-wavelength grating structure group G2.

The quantum light source 400 may include at least one of semiconductor-based quantum dots, a solid-state defect, or two-dimensional (2D) material-based quantum dots.

In some embodiments of the inventive concept, the quantum light source 400 may be provided as a semiconductor thin film including the semiconductor-based quantum dots containing the second material. The second material may include indium arsenide (InAs) or indium gallium arsenide (InGaAs). For example, the quantum light source 400 may be semiconductor quantum dots based on indium arsenide (InAs) quantum dots or indium gallium arsenide (InGaAs) quantum dots.

In some embodiments of the inventive concept, the quantum light source 400 may be manufactured in the form of a waveguide having a sharp tip. A length of the first direction D1 in the form of a waveguide may range of about 2 μm to about 100 μm. A width of the second direction D2 in the form of a waveguide may range of about 100 nm to about 1000 nm. The quantum light source 400 may include a periodic hole therein and a reflective structure disposed in the quantum light source 400.

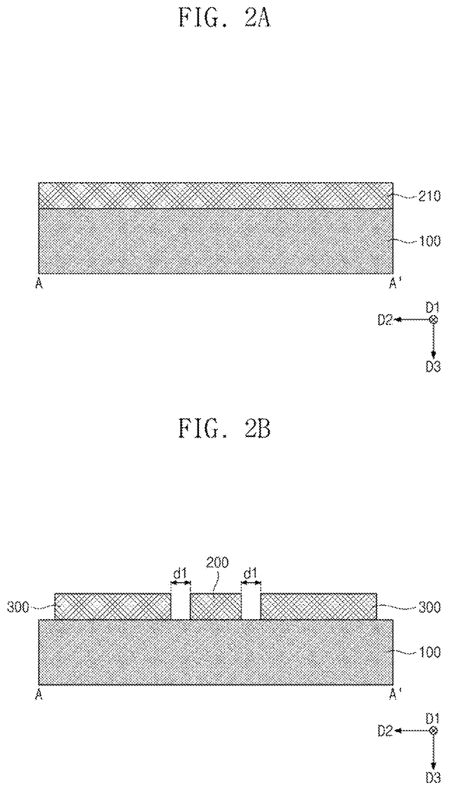

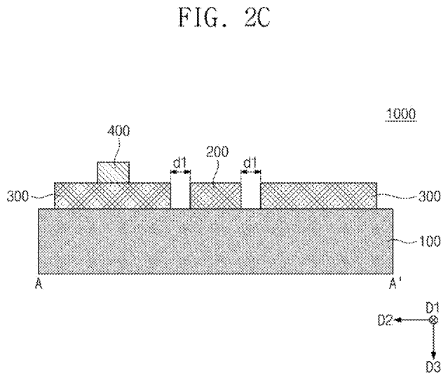

FIGS. 2A, 2B, and 2C are cross-sectional views for explaining a method for manufacturing the quantum optical device 1000 according to some embodiments of the inventive concept. In detail, FIGS. 2A, 2B, and 2C illustrate a process of manufacturing the quantum optical device according to FIGS. 1A and 1B.

Referring to FIG. 2A, a substrate 100 may be prepared. An optical pattern layer 210 may be formed on the substrate 100. The optical pattern layer 210 may include one of silicon (Si), silicon nitride (SiNx), or lithium niobate (LiNbO₃).

Referring to FIG. 2B, an optical waveguide 200 and sub-wavelength grating structures 300 may be formed on the substrate 100. The forming of the optical waveguide 200 and the sub-wavelength grating structures 300 may include patterning the optical pattern layer 210. The patterning of the optical pattern layer 210 may include well-known photolithography processes and etching processes.

Referring to FIG. 2C, a quantum light source 400 may be coupled to the sub-wavelength grating structures 300. The coupling of the quantum light source 400 to the sub-wavelength grating structures 300 may include forming the quantum light source 400 and disposing the quantum light source 400 on the sub-wavelength grating structures 300. The forming of the quantum light source 400 may include forming a semiconductor thin film including any one of GaAs, InP, and GaN, and patterning the semiconductor thin film using a photolithography process. The disposing of the quantum light source 400 on the sub-wavelength grating structures 300 may include moving the quantum light source 400 onto the sub-wavelength grating structures 300 using an adhesive layer such as a viscous polymer (e.g., PDMS) and then removing the adhesive layer (polymer adhesive method). The quantum light source 400 may include a material different from that of the sub-wavelength grating structures 300, and the disposing of the quantum light source 400 on the sub-wavelength grating structures 300 may be hetero-junction. According to other embodiments, the disposing of the quantum light source 400 on the sub-wavelength grating structures 300 may include a micro-transfer method or a flip-chip bonding method.

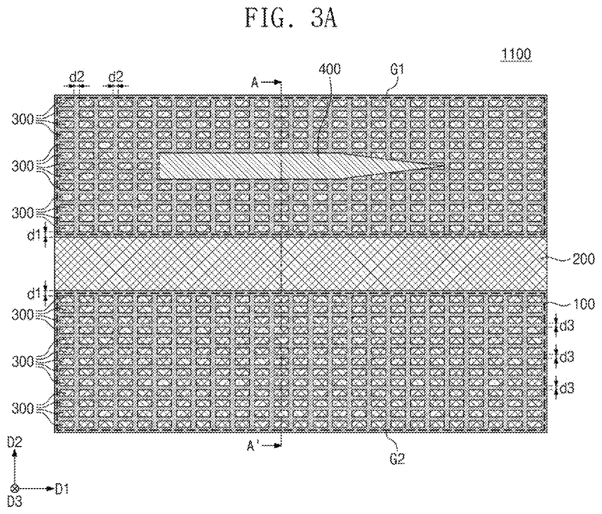

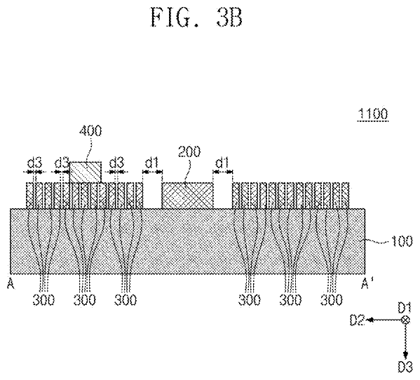

FIG. 3A is a plan view illustrating the quantum optical device 1100 according to some embodiments of the inventive concept. FIG. 3B is a cross-sectional view taken along line A-A′ of FIG. 3A.

Referring to FIGS. 3A and 3B, the sub-wavelength grating structures 300 may be arranged on the substrate 100 in a plurality of rows and a plurality of columns along the first direction D1 and the second direction D2 within the first sub-wavelength grating structure group G1 and the second sub-wavelength grating structure group G2, respectively. The first sub-wavelength grating structure group G1 and the second sub-wavelength grating structure group G2 may be spaced apart from each other by the first distance d1 in the second direction D2 with respect to the optical waveguide 200. The first distance d1 may range of about 10 nm to about 200 nm. The sub-wavelength grating structures 300 may be spaced apart from each other by a second distance d2 in the first direction D1. The sub-wavelength grating structures 300 may be spaced apart from each other by a third distance d3 in the second direction D2. The second distance d2 may be shorter than the wavelength of the quantum light source 400, and more specifically, the second distance d2 may range of about 50 nm to about 2 μm. The third distance d3 may be shorter than the wavelength of the quantum light source 400.

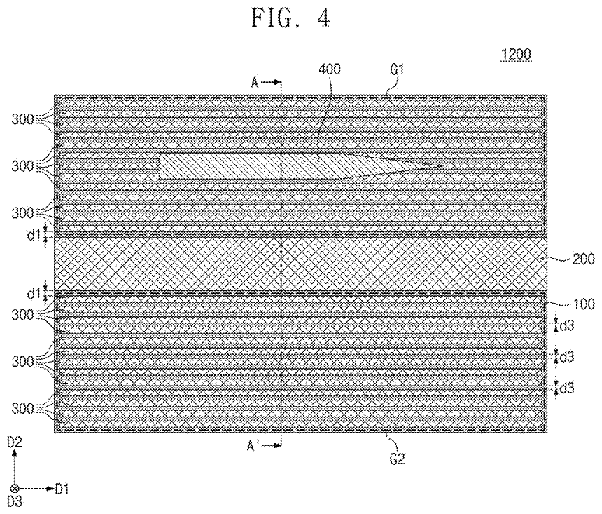

FIG. 4 is a plan view illustrating a quantum optical device 1200 according to some embodiments of the inventive concept.

Referring to FIG. 4, the sub-wavelength grating structures 300 may be arranged in a plurality of rows on the substrate 100 in the first sub-wavelength grating structure group G1 and the second sub-wavelength grating structure group G2 along the second direction D2, respectively. Each of the sub-wavelength grating structures 300 may have a width in the first direction D1, which is greater than a width in the second direction D2. The first sub-wavelength grating structure group G1 and the second sub-wavelength grating structure group G2 may be spaced apart from each other by the first distance d1 in the second direction D2 with respect to the optical waveguide 200. The sub-wavelength grating structures 300 may be spaced apart from each other by the third distance d3 in the second direction D2. The third distance d3 may be shorter than the wavelength of the quantum light source 400.

The embodiments of FIGS. 1A, 3A, and 4 may be selected in consideration of optical mode characteristics, alignment tolerance, and process difficulty of the quantum optical device.

In more detail, the sub-wavelength grating structures 300 of the quantum optical device 1000 according to the embodiment of FIG. 1A may be arranged to be perpendicular to the optical waveguide 200, thereby providing a high tolerance for small-scale alignment errors. The sub-wavelength grating structures 300 of the quantum optical device according to the embodiment of FIG. 1A may induce photons emitted from the quantum light source 400 so as to be coupled to the optical waveguide 200 in a transverse electric mode (TE mode).

The sub-wavelength grating structures 300 of the quantum optical device 1100 according to the embodiment of FIG. 3A may improve optical coupling efficiency through complex diffraction and scattering effects and may provide high tolerance characteristics even in the case of large-scale alignment errors.

In the embodiment of FIG. 4, the sub-wavelength grating structures 300 of the quantum optical device 1200 may guide photons emitted from the quantum light source 400 in a transverse magnetic mode (TM mode) so that the photons are efficiently coupled to the optical waveguide 200 to improve the optical coupling efficiency. In addition, even in the case of the large alignment errors, the optical coupling efficiency may be stably maintained.

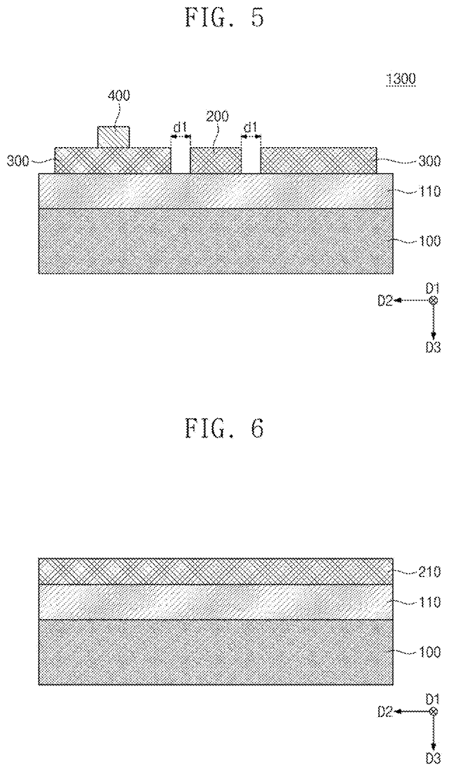

FIG. 5 is a cross-sectional view illustrating a quantum optical device 1300 according to some embodiments of the inventive concept.

Referring to FIG. 5, the quantum optical device 1300 according to some embodiments of the inventive concept may further include a piezoelectric material layer 110. The piezoelectric material layer 110 may be interposed between the substrate 100 and the sub-wavelength grating structures 300 and between the substrate 100 and the optical waveguide 200.

The piezoelectric material layer 110 may include a material capable of exhibiting a piezoelectric effect by which physical deformation is induced in response to an externally applied voltage. In more detail, the piezoelectric material layer 110 may include one or more of the group consisting of lead zirconate titanate (Pb[Zr3Ti₁₋ₓ]O₃, PZT), lead zirconate titanate-lead titanate (Pb[Zr3Ti₁₋ₓ]O₃—PbTiO₃, PZT-PT), aluminum nitride (AlN), zinc oxide (ZnO), lithium niobate (LiNbO₃), and/or polyvinylidene fluoride (PVDF).

The piezoelectric material layer 110 may finely control a refractive index of each of the sub-wavelength grating structures 300 and the optical waveguide 200 to induce the photons emitted from the quantum light source 400 to be coupled to the optical waveguide 200 with higher efficiency. Thus, the piezoelectric material layer 110 may simultaneously provide alignment error correction, optimization of the optical coupling efficiency, and improvement of structural stability of the quantum optical device 1300.

FIG. 6 is a cross-sectional view for explaining a method for manufacturing the quantum optical device 1300 according to some embodiments of the inventive concept.

Referring to FIG. 6, a substrate 100 may be prepared.

A piezoelectric material layer 110 may be formed on the substrate 100. The forming of the piezoelectric material layer 110 may be performed by depositing a piezoelectric material on the substrate 100 through a well-known thin-film deposition process. An optical pattern layer 210 may be formed on the piezoelectric material layer 110. The process of forming the optical pattern layer 210 may be performed through a well-known thin-film deposition process. Thus, as described above with reference to FIG. 2B, an optical waveguide 200 and sub-wavelength grating structures 300 may be formed on the optical pattern layer 210. In addition, as described with reference to FIG. 2C, the quantum light source 400 may be coupled to the sub-wavelength grating structures 300 to form the quantum optical device 1300 of FIG. 5.

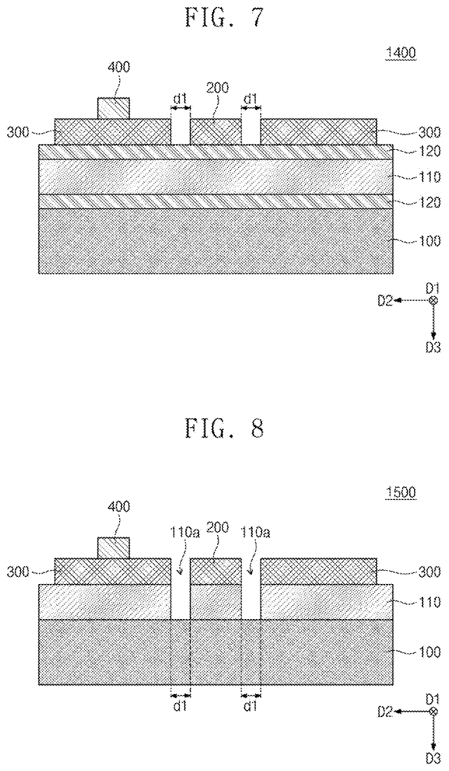

FIG. 7 is a cross-sectional view illustrating a quantum optical device 1400 according to some embodiments of the inventive concept. Unless otherwise described below, descriptions that are duplicated with those of FIG. 5 will be omitted.

Referring to FIG. 7, an optical device according to some embodiments may further include metal electrodes 120 that are respectively arranged on a top surface and a bottom surface of a piezoelectric material layer 110. The metal electrodes 120 may apply a voltage to the piezoelectric material layer 110 to induce mechanical deformation of the piezoelectric material layer 110. A refractive index of each of the sub-wavelength grating structures 300 and the optical waveguide 200 may be finely controlled through mechanical deformation of the piezoelectric material layer 110 to optimize optical coupling efficiency.

The metal electrodes 120 may include metal materials such as gold (Au), silver (Ag), aluminum (Al), titanium (Ti), chromium (Cr), or indium tin oxide (ITO).

FIG. 8 is a cross-sectional view illustrating a quantum optical device 1500 according to some embodiments of the inventive concept. Unless otherwise described below, descriptions that are duplicated with those of FIG. 7 will be omitted.

Referring to FIG. 8, an upper surface of the piezoelectric material layer 110 may include recesses 110a. Each of the recesses 110a may be a portion recessed toward the substrate 100. A width of each of the recesses 110a in the second direction D2 may be equal to the first distance d1.

When a voltage is applied to the piezoelectric material layer 110, the recesses 110a may guide stress generated in the piezoelectric material layer 110 so that the stress is only transferred to the sub-wavelength grating structures 300. In addition, the stress transfer to the optical waveguide 200 may be blocked to independently perform a stress control over the sub-wavelength grating structures 300 and the optical waveguide 200. Thus, the recesses 110a may improve the optical coupling efficiency of the quantum optical device 1500 and provide a structure with high tolerance for errors. The recesses 110a may be defined through an etching process of the piezoelectric material layer 110.

The quantum optical device according to the embodiment of the inventive concept may include the sub-wavelength grating structures disposed around the optical waveguide and a quantum light source on the sub-wavelength grating structures.

The sub-wavelength grating structures may improve the photon coupling efficiency of the optical waveguide from the quantum light source. The sub-wavelength grating structures may relieve the deterioration in coupling efficiency due to the alignment error between the quantum light source and the optical waveguide and improve the tolerance.

Although the embodiment of the inventive concept is described with reference to the accompanying drawings, those with ordinary skill in the technical field of the inventive concept pertains will be understood that the inventive concept can be carried out in other specific forms without changing the technical idea or essential features. Thus, the above-disclosed embodiments are to be considered illustrative and not restrictive.

What is claimed is:

1. A quantum optical device comprising:
a substrate;
an optical waveguide disposed on the substrate to extend in a first direction parallel to a top surface of the substrate;
a first sub-wavelength grating structure group and a second sub-wavelength grating structure group, which are disposed on the substrate and are spaced apart from each other in a second direction that is parallel to the top surface of the substrate and perpendicular to the first direction with the optical waveguide between the first sub-wavelength grating structure group and the second sub-wavelength grating structure group; and
a quantum light source disposed on either one of first sub-wavelength grating structure group and the second sub-wavelength grating structure group,
each of the first sub-wavelength grating structure group and the second sub-wavelength grating structure group comprises a plurality of sub-wavelength grating structures.

2. The quantum optical device of claim 1, wherein the sub-wavelength grating structures are disposed in a plurality of columns along the first direction, and
each of the sub-wavelength grating structures has a width in the second direction, which is greater than a width in the first direction.

3. The quantum optical device of claim 1, wherein the sub-wavelength grating structures are disposed in a plurality of rows and a plurality of columns along the first direction and the second direction.

4. The quantum optical device of claim 1, wherein the sub-wavelength grating structures are disposed in a plurality of rows along the second direction, and
each of the sub-wavelength grating structures has a width in the first direction, which is greater than a width in the second direction.

5. The quantum optical device of claim 1, wherein the sub-wavelength grating structures adjacent to each other in the first direction among the sub-wavelength grating structures are spaced apart from each other by a second distance in the first direction,
wherein the second distance is shorter than a wavelength of the quantum light source.

6. The quantum optical device of claim 1, wherein the sub-wavelength grating structures adjacent to each other in the second direction among the sub-wavelength grating structures are spaced apart from each other by a first distance in the second direction,
wherein the first distance is shorter than a wavelength of the quantum light source.

7. The quantum optical device of claim 1, wherein each of the optical waveguide and the sub-wavelength grating structures comprises a first material, and the quantum light source comprises a second material,
wherein the first material and the second material are different from each other.

8. The quantum optical device of claim 7, wherein the first material is silicon (Si), silicon nitride (SiNx), or lithium niobate (LiNbO₃).

9. The quantum optical device of claim 7, wherein the second material is indium arsenide (InAs) quantum dots or indium gallium arsenide (InGaAs).

10. The quantum optical device of claim 1, wherein the quantum light source and the sub-wavelength grating structures are in contact with each other.

11. The quantum optical device of claim 1, wherein the optical waveguide and the quantum light source are spaced apart from each other.

12. The quantum optical device of claim 1, wherein the optical waveguide and the quantum light source are spaced apart from each other in the second direction in a planar view.

13. The quantum optical device of claim 1, wherein the quantum light source has a line shape with a sharp tip.

14. The quantum optical device of claim 13, wherein the quantum light source comprises a periodic hole inside the quantum light source and a reflective structure disposed inside the quantum light source.

15. The quantum optical device of claim 1, further comprising a piezoelectric material layer interposed between the substrate and the sub-wavelength grating structures.

16. The quantum optical device of claim 15, further comprising metal electrodes disposed on top and bottom surfaces of the piezoelectric material layer, respectively.

17. The quantum optical device of claim 15, wherein the piezoelectric material layer comprises a first recess and a second recess,
wherein the first recess is disposed between the first sub-wavelength grating structure group and the optical waveguide, and
the second recess is disposed between the second sub-wavelength grating structure group and the optical waveguide.

18. A quantum optical device comprising:
a substrate;
an optical waveguide disposed on the substrate to extend in a first direction parallel to a top surface of the substrate;
sub-wavelength grating structures disposed along both side surfaces of the optical waveguide on the substrate; and
a quantum light source disposed on the sub-wavelength grating structures,
wherein the optical waveguide and the quantum light source do not overlap each other.

19. The quantum optical device of claim 18, wherein the sub-wavelength grating structures are disposed in a plurality of columns along the first direction, and
each of the sub-wavelength grating structures has a width in a second direction parallel to the top surface of the substrate and perpendicular to the first direction, which is greater than a width of the sub-wavelength grating structure in the first direction.

20. The quantum optical device of claim 18, wherein the sub-wavelength grating structures are disposed in a plurality of rows along a second direction that is parallel to the top surface of the substrate and perpendicular to the first direction, and
each of the sub-wavelength grating structures has a width in the first direction, which is greater than a width in the second direction.
